(19) United States
(12) Patent Application Publication
(10) Pub. No.: US 2021/0016904 A1
(43) Pub. Date: Jan. 21, 2021

(54) SNACK BAG WITH INTEGRATED POCKET AND METHOD

(71) Applicants: Tyrell Anthony Walker, Woodbridge (CA); Benjamin Gulak, Woodbridge (CA)

(72) Inventors: Tyrell Anthony Walker, Woodbridge (CA); Benjamin Gulak, Woodbridge (CA)

(21) Appl. No.: 16/512,895

(22) Filed: Jul. 16, 2019

(51) Int. Cl. B65B 5/06; A47K 10/32

(52) U.S. Cl. CPC B65B 5/061; A47K 10/32; B65G 2201/0238; A47K 2010/3266; B65B 5/064

(57) ABSTRACT

An integrated cleansing wipe system for use with packaged items including a first-bag-body having a front-panel; a rear-panel; and an inner-volume; a second-bag-body including a proximate-panel; a tab-panel; and an interior-volume; and a cleansing wipe; wherein the package assembly is the first-bag-body and the second-bag-body in integral and functional combination; wherein the first-bag-body is defined by the front-panel and the rear-panel in a sealed relationship such that at least one food item is able to be sealingly stored in the inner-volume prior to be opened for consumption of the at least one food item stored therein. The interior-volume of the second-bag-body is defined by the proximate-panel being sealingly adjacent against the front-panel to removably contain the cleansing wipe. The tab-panel is able to be pulled to access the cleansing wipe for a user to clean hands after consumption of the at least one food item.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of special receptacle or package of existing art and more specifically relates to special receptacle or package assemblage or kit including tissue dispensing means.

### RELATED ART

A large percentage of people are on the go and committed to leading an active lifestyle. Whether leading an active single lifestyle, or an active chaotic family life, convenience is required. When out for the day or during long periods of travel it is not always possible for the active enthusiast to pack or carry multiple items or necessities. Further, when travelling by car, truck, airplane or train it may not be possible or safe to carry multiple items, or access said items from storage or luggage, due to space constraints, safety concerns or transportation restrictions and guidelines. Children also lead an active lifestyle. Some children attend childcare or daycare facilities, school, and require easy ways to carry food and snacks, as well as the ability and convenience to clean hands or faces after food consumption, and easily dispose of packaging. Further, when traveling to difficult places, such as the beach, woods, or mountains transporting multiple items with minimal effort and ease of storage and convenient disposal is a must.

U.S. Pat. No. U.S. Pub. No. 2007/0090001 to Alina Lipaysky relates to snack naps. The described snack naps includes producing and selling a wet or dry napkin together with packaged food items allowing consumers to clean hands after the product has been consumed. New product composition involves combining individually sold chips or other snacks with a wet or dry napkin and to be sold as a part of such product. Consumption of the product will be more convenient, especially outside of the home where the option of washing hands is not available.

### SUMMARY OF THE INVENTION

In view of the foregoing disadvantages inherent in the known special receptacle or package art, the present disclosure provides a novel snack bag with an integrated pocket. The general purpose of the present disclosure, which will be described subsequently in greater detail, is to provide a snack bag with integrated pocket such that user's can clean their hands after consuming the packaged comestible.

An integrated cleansing wipe system for use with packaged items is disclosed herein comprising a first-bag-body having a front-panel; a rear-panel; and an inner-volume; a second-bag-body including a proximate-panel; a tab-panel; and an interior-volume; and a cleansing wipe. The package assembly comprises the first-bag-body and the second-bag-body in integral and functional combination; wherein the first-bag-body is defined by the front-panel and the rear-panel in a sealed relationship such that at least one food item is able to be sealingly stored in the inner-volume prior to be opened for consumption of the at least one food item stored therein. The interior-volume of the second-bag-body is defined by the proximate-panel being sealingly adjacent against the front-panel to removably contain the cleansing wipe. As such, the tab-panel is able to be pulled to access the cleansing wipe for a user to clean his/her hands after consumption of the at least one food item.

Various forms of the present invention are envisioned such as inclusion of a wetnap (or dry version, napkin or other) in the bag of comestibles when being packaged and sealed for delivery, alternately an enclosed cleansing wipe may be crimped to the upper portion of a chip bag during the sealing process. Generally speaking the cleansing wipe may be combined with the at least one food item for use after the food is consumed. For example the present invention may be used with popcorn cups in movie theatres, or on fast food hamburger boxes or French fry containers and be used as such. The embodiments described herein are to be taken as exemplary for purposes of enablement and not to be limited in any way.

A method of manufacture for the integrated cleansing wipe system for use with packaged items is also disclosed herein; the method comprising the steps of: providing a first-bag-body; providing a second-bag-body; and providing a cleansing wipe; adhering the second-bag-body to the first-bag-body; inserting the cleansing wipe within an interior-volume; sealing the interior-volume such that the cleansing wipe is able to remain moist for an extended shelf-life; providing a package assembly including the first-bag-body having a front-panel; a rear-panel; and an inner-volume; the second-bag-body including a proximate-panel; a tab-panel; and the interior-volume; and the cleansing wipe. The package assembly comprises the first-bag-body and the second-bag-body in integral and functional combination suitable to be filled with a comestible. The method may comprise the steps of: blowing nitrogen gas into the inner-volume to preserve the comestible (comprising at least one food item stored therein); and sealing the inner-volume of the first-bag-body; and delivering the package assembly to a distributer.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a snack bag with integrated pocket, constructed and operative according to the teachings of the present disclosure.

FIG. 1 is a perspective view of the snack bag with integrated pocket during an ‘in-use’ condition, according to an embodiment of the disclosure.

FIG. 2 is a perspective view of the snack bag with integrated pocket of FIG. 1, according to an embodiment of the present disclosure.

FIG. 3 is a perspective view of the snack bag with integrated pocket of FIG. 1, according to an embodiment of the present disclosure.

FIG. 4 is a perspective view of the snack bag with integrated pocket of FIG. 1, according to an embodiment of the present disclosure.

FIG. 5 is a flow diagram illustrating a method of manufacture for the snack bag with integrated pocket, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a special receptacle or package, and packaged assemblage or kit including tissue dispensing means and more particularly to a snack bag with integrated pocket as used to improve the ease of process of food consumption, and storage, transportation and disposal after use.

Generally, the device is a disposable chip, snack or food bag containing an integrated compartment to conveniently hold dry or wet paper product.

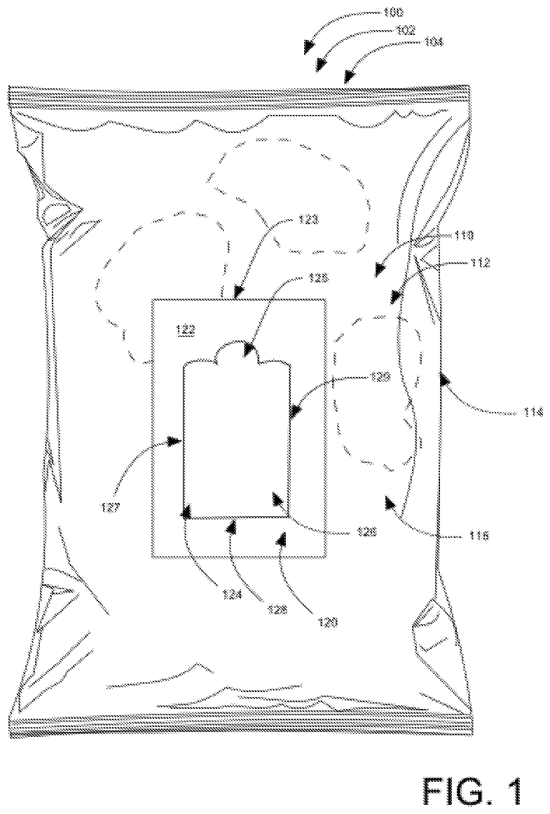

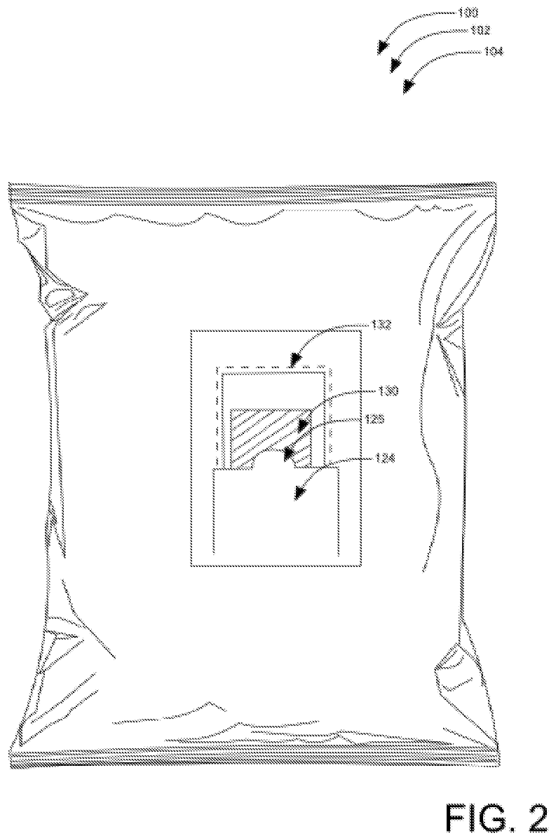

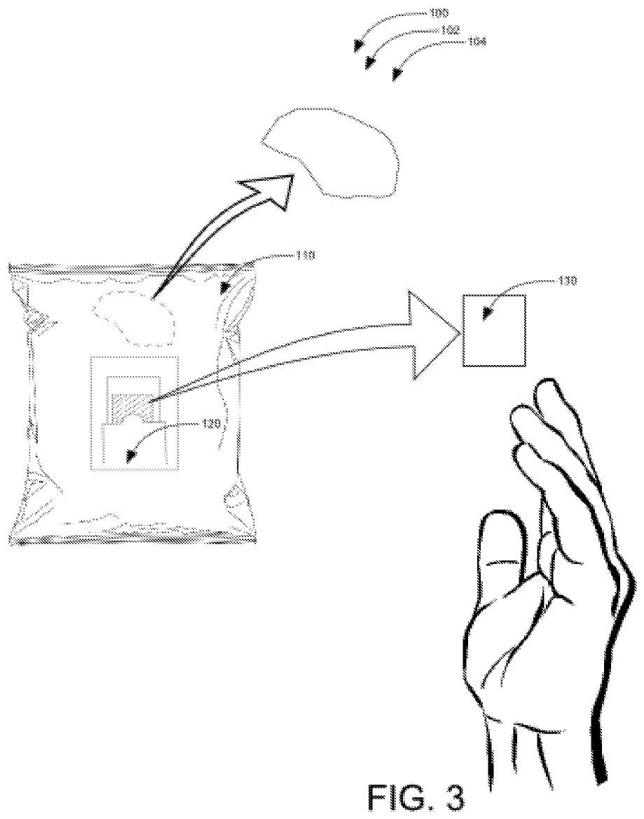

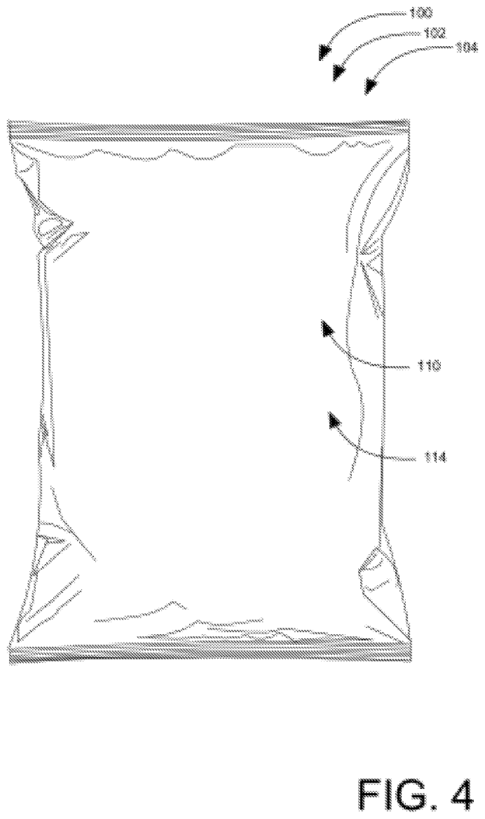

Referring now more specifically to the drawings by numerals of reference, there is shown in FIGS. 1-4, various views of an integrated cleansing wipe system 100.

FIG. 1 shows an integrated cleansing wipe system 100 during an ‘in-use’ condition 150, according to an embodiment of the present disclosure. Here, the integrated cleansing wipe system 100 may be beneficial for use by a user to provide a snack bag with integrated pocket 102. As illustrated, the integrated cleansing wipe system 100 may be as a package assembly 104 including: a first-bag-body 110 having a front-panel 112; a rear-panel 114; and an inner-volume 116; a second-bag-body 120 including a proximate-panel 122; a tab-panel 124; and an interior-volume 126; and a cleansing wipe 130. The package assembly 104 comprises the first-bag-body 110 and the second-bag-body 120 in integral and functional combination.

The first-bag-body 110 is defined by the front-panel 112 and the rear-panel 114 in a sealed relationship such that at least one food item is able to be sealingly stored in the inner-volume 116 prior to be opened for consumption of the at least one food item stored therein. The interior-volume 126 of the second-bag-body 120 is defined by the proximate-panel 122 being sealingly adjacent against the front-panel 112 to removably contain the cleansing wipe 130. The tab-panel 124 is able to be pulled to access the cleansing wipe 130 for a user to clean hands after consumption of the at least one food item.

Referring now to the second-bag-body 120; the second-bag-body 120 is smaller than the first-bag-body 110 and is mounted to (integrally with) the first-bag-body 110 on the front-panel 112. The tab-panel 124 has a top-tab 125 able to be gripped by the user. In this particular embodiment the tab-panel 124 is integral to the proximate-panel 122 on a bottom edge 128, and two side edges (127, 128) and a top-edge 123 of the tab-panel 124 are adhesively removably coupled to the proximate-panel 122 to enclose the interior-volume 126 of the second-bag-body 120 to store the cleansing wipe 130 therein.

The first-bag-body 110 of the integrated cleansing wipe system 100 comprises nitrogen gas (or suitable equivalent) blown into the inner-volume 116 to preserve the at least one food item stored therein. The first-bag-body 110 in preferred embodiments is plastic as is the second-bag-body 120. The at least one food item discussed herein refers to a comestible, such as for example potato chips. Other food products may be stored therein however potato chips has been provided as exemplary. Other examples may include: packaged nuts, wasabi peas and spiced corn packs or the like.

The cleansing wipe 130 is a moist towelette; wherein the moist towelette is folded prior to use and may be unfolded for use in wiping hands. The moist towelette may comprise isopropyl alcohol or other suitable equivalent.

Relationally speaking, the proximate-panel 122 is flat adjacent the front-panel 112 before being opened. When the tab-panel 124 is moved (manipulated) away from the proximate-panel 122 adhesive 132 between the tab-panel 124 and the proximate-panel 122 is uncoupled. The second-bag-body 120 uses the front-panel 112 of the first-bag-body 110 as a means of enclosing the cleansing wipe 130; the interior-volume 126 enclosed by the front-panel 112. The adhesive 132 creates a sealing means between the tab-panel 124 and the proximate-panel 122 such that the cleansing wipe 130 is able to remain moist for an extended shelf-life. Any suitable adhesive 132 may be used.

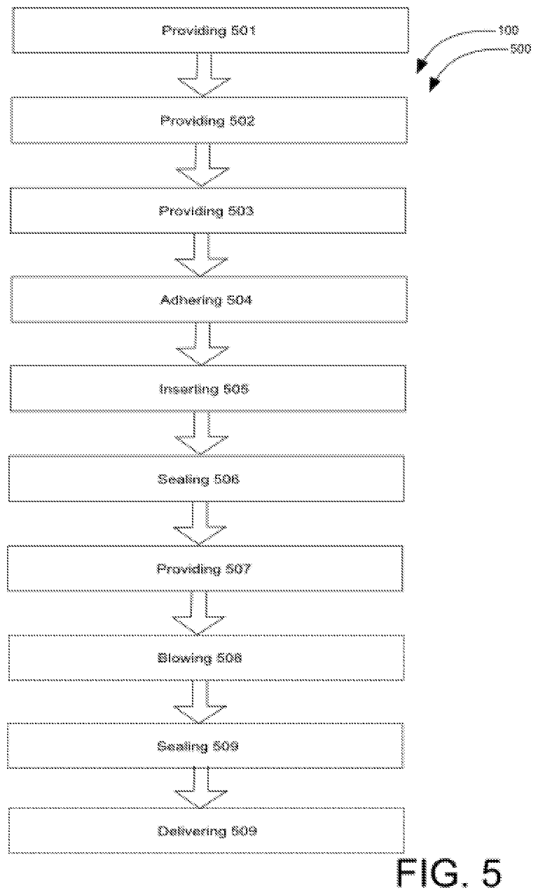

Referring now to FIG. 5 showing a flow diagram illustrating a method of manufacture 500 for the integrated cleansing wipe system for use with packaged items, according to an embodiment of the present disclosure. In particular, the method of manufacture 500 may include one or more components or features of the integrated cleansing wipe system 100 as described above. As illustrated, the method of use 500 may include the steps of: step one 501, providing a first-bag-body; step two 502, providing a second-bag-body; step three 503, providing a cleansing wipe; step four 504 adhering the second-bag-body to the first-bag-body; step five 505 inserting the cleansing wipe within an interior-volume; step six 506 sealing the interior-volume such that the cleansing wipe is able to remain moist for an extended shelf-life; step seven 507 providing a package assembly including the first-bag-body having a front-panel; a rear-panel; and an inner-volume; the second-bag-body including a proximate-panel; a tab-panel; and the interior-volume; and the cleansing wipe; wherein the package assembly comprises the first-bag-body and the second-bag-body in integral and functional combination suitable to be filled with a comestible. The method 500 may further comprise the steps of: step eight 508 blowing nitrogen gas into the inner-volume to preserve the comestible comprising at least one food item stored therein; step nine 509 sealing the inner-volume of the first-bag-body; and step ten 510 delivering the package assembly to a distributer.

It should be noted that steps 508-510 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for integrated cleansing wipe system for use with packaged items are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in said appended claims:

1. An integrated cleansing wipe system for use with packaged items comprising:
a package assembly including
a first-bag-body having
a front-panel;
a rear-panel; and
an inner-volume;
a second-bag-body including
a proximate-panel;
a tab-panel; and
an interior-volume; and
a cleansing wipe;
wherein said package assembly comprises said first-bag-body and said second-bag-body in integral and functional combination;
wherein said first-bag-body is defined by said front-panel and said rear-panel in a sealed relationship such that at least one food item is able to be sealingly stored in said inner-volume prior to be opened for consumption of said at least one food item stored therein;
wherein said interior-volume of said second-bag-body is defined by said proximate-panel being sealingly adjacent against said front-panel to removably contain said cleansing wipe; and
wherein said tab-panel is able to be pulled to access said cleansing wipe for a user to clean hands after consumption of said at least one food item.

2. The integrated cleansing wipe system for use with packaged items of claim 1, wherein said second-bag-body is smaller than said first-bag-body and is mounted to said first-bag-body on said front-panel.

3. The integrated cleansing wipe system for use with packaged items of claim 1, wherein said tab-panel has a top-tab able to be gripped by said user.

4. The integrated cleansing wipe system for use with packaged items of claim 1, wherein said tab-panel is integral to said proximate-panel on a bottom edge, and two side edges and a top-edge of said tab-panel are adhesively removably coupled to said proximate-panel to enclose said interior-volume of said second-bag-body to store said cleansing wipe therein.

5. The integrated cleansing wipe system for use with packaged items of claim 1, wherein said first-bag-body comprises nitrogen gas blown into said inner-volume to preserve said at least one food item stored saidrein.

6. The integrated cleansing wipe system for use with packaged items of claim 1, wherein said first-bag-body is plastic.

7. The integrated cleansing wipe system for use with packaged items of claim 1, wherein said second-bag-body is plastic.

8. The integrated cleansing wipe system for use with packaged items of claim 1, wherein said at least one food item stored is a comestible.

9. The integrated cleansing wipe system for use with packaged items of claim 8, wherein said comestible stored is potato chips

10. The integrated cleansing wipe system for use with packaged items of claim 1, wherein said cleansing wipe is a moist towelette.

11. The integrated cleansing wipe system for use with packaged items of claim 10, wherein said moist towelette is folded prior to use.

12. The integrated cleansing wipe system for use with packaged items of claim 11, wherein said moist towelette comprises isopropyl alcohol.

13. The integrated cleansing wipe system for use with packaged items of claim 4, wherein said proximate-panel is flat adjacent said front-panel before being opened.

14. The integrated cleansing wipe system for use with packaged items of claim 1, wherein when said tab-panel is moved away from said proximate-panel adhesive between said tab-panel and said proximate-panel is uncoupled.

15. The integrated cleansing wipe system for use with packaged items of claim 1, wherein said second-bag-body uses said front-panel of said first-bag-body as a means of enclosing said cleansing wipe, said interior-volume enclosed by said front-panel.

16. The integrated cleansing wipe system for use with packaged items of claim 14, wherein said adhesive creates a sealing means between said tab-panel and said proximate-panel such that said cleansing wipe is able to remain moist for an extended shelf-life.

17. An integrated cleansing wipe system for use with packaged items comprising:
a package assembly including
a first-bag-body having
a front-panel;
a rear-panel; and
an inner-volume;
a second-bag-body including a proximate-panel;
a tab-panel; and
an interior-volume; and
a cleansing wipe;
wherein said package assembly comprises said first-bag-body and said second-bag-body in integral and functional combination;
wherein said first-bag-body is defined by said front-panel and said rear-panel in a sealed relationship such that at least one food item is able to be sealingly stored in said inner-volume prior to be opened for consumption of said at least one food item stored therein;
wherein said interior-volume of said second-bag-body is defined by said proximate-panel being sealingly adjacent against said front-panel to removably contain said cleansing wipe;
wherein said second-bag-body is smaller than said first-bag-body and is mounted to said first-bag-body on said front-panel;
wherein said tab-panel has a top-tab able to be gripped by said user;
wherein said tab-panel is integral to said proximate-panel on a bottom edge, and two side edges and a top-edge of said tab-panel are adhesively removably coupled to said proximate-panel to enclose said interior-volume of said second-bag-body to store said cleansing wipe therein;
wherein said first-bag-body comprises nitrogen gas blown into said inner-volume to preserve said at least one food item stored therein;
wherein said first-bag-body and said second-bag-body are flexible plastic;
wherein said at least one food item stored is a comestible;
wherein said cleansing wipe is a moist towelette;
wherein said moist towelette is folded prior to use;
wherein said moist towelette comprises isopropyl alcohol;
wherein said proximate-panel is flat adjacent said front-panel before being opened;
wherein when said tab-panel is moved away from said proximate-panel adhesive between said tab-panel and said proximate-panel is uncoupled;
wherein said second-bag-body uses said front-panel of said first-bag-body as a means of enclosing said cleansing wipe, said interior-volume enclosed by said front-panel;
wherein said adhesive creates a sealing means between said tab-panel and said proximate-panel such that said cleansing wipe is able to remain moist for an extended shelf-life; and
wherein said tab-panel is able to be pulled to access said cleansing wipe for a user to clean hands after consumption of said at least one food item.

18. The integrated cleansing wipe system for use with packaged items of claim 17, wherein said comestible comprises potato chips.

19. A method of manufacture for said integrated cleansing wipe system for use with packaged items, said method comprising said steps of:
providing a first-bag-body;
providing a second-bag-body;
providing a cleansing wipe;
adhering said second-bag-body to said first-bag-body;
inserting said cleansing wipe within an interior-volume;
sealing said interior-volume such that said cleansing wipe is able to remain moist for an extended shelf-life;
providing a package assembly including
said first-bag-body having
a front-panel;
a rear-panel; and
an inner-volume;
said second-bag-body including
a proximate-panel;
a tab-panel; and
said interior-volume; and
said cleansing wipe; and
wherein said package assembly comprises said first-bag-body and said second-bag-body in integral and functional combination suitable to be filled with a comestible.

20. The method of claim 19, further comprising said steps of:
blowing nitrogen gas into said inner-volume to preserve said comestible comprising at least one food item stored therein; and
sealing said inner-volume of said first-bag-body; and
delivering said package assembly to a distributer.
